(19) United States
(12) Patent Application Publication
(10) Pub. No.: US 2005/0141459 A1
(43) Pub. Date: Jun. 30, 2005

(54) Apparatus and associated methods to reduce management overhead in a wireless communication system

(75) Inventors: Qinghua Li, Sunnyvale, CA (US); Xintian E. Lin, Palo Alto, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Intel Corporation

(21) Appl. No.: 10/748,306

(22) Filed: Dec. 29, 2003

(51) Int. Cl. H04Q 7/00

(52) U.S. Cl. 370/334; 370/338

(57) ABSTRACT

An apparatus and associated methods to reduce management overhead in a wireless communication system are generally introduced herein.

### CROSS-REFERENCE TO RELATED APPLICATION

This disclosure is related to the following pending U.S. patent applications Ser. No. TBD, entitled “An Efficient Channel Estimator for SDMA”, by Qinghua Li, Xintian E. Lin, filed on TBD; and Ser. No.: TBD (P17922), entitled “Communication Overhead Reduction Apparatus, Systems and Methods” filed on Dec. 15, 2003 by Qinghua Li, Xintian E. Lin, each of which is assigned to the assignee of the embodiments disclosed herein, Intel Corporation.

### TECHNICAL FIELD

Various embodiments described herein relate to communications generally, including apparatus, systems, and methods to reduce management overhead in a wireless communication system and, in particular, to reduce calibration and training overhead associated with a wireless communication channel.

### BACKGROUND INFORMATION

Spatial multiplexing communications system performance, including SDMA (space division, multiple access) and MIMO (multiple-input, multiple-output) systems, may be improved by the activities of training and calibration. Training may include transmitting known signals to a receiver to increase the reliability of estimating channel state information. While longer training sequences may provide increased reception accuracy, the use of such sequences may also reduce the advantage to be gained by using spatial multiplexing in the first place (i.e., high data rates). Similarly, while calibrating transmitter power and receiver gains can contribute to improved data transmission rates, the additional time required for periodic calibration may decrease the ultimate system capability to communicate large amounts of data in a short time span.

### BRIEF DESCRIPTION OF THE DRAWINGS

Embodiments of the present invention are illustrated by way of example, and not by way of limitation, in the figures of the accompanying drawings in which like reference numerals refer to similar elements and in which:

FIG. 1 is a block diagram of apparatus and a system operating according to various embodiments;

FIG. 2 is a block diagram of apparatus and a system operating according to various embodiments;

FIG. 3 is a block diagram of apparatus and a system operating according to various embodiments;

FIG. 4 is a block diagram of exemplary packet formats that can be utilized by the apparatus and system of FIG. 3;

FIGS. 5A and 5B are a block diagram of an apparatus operating according to various embodiments, as well as an exemplary packet format which may be implemented thereby, respectively;

FIG. 6 is a flow chart illustrating several training and calibration methods according to various embodiments;

FIG. 7 is a flow chart illustrating several alternative training and calibration methods according to various embodiments;

FIG. 8 is a block diagram of an article according to various embodiments;

FIG. 9 is a block diagram of an example apparatus and a system operating according to various embodiments;

FIG. 10 is a block diagram of an example apparatus and a system operating according to various embodiments; and

FIG. 11 is a block diagram of apparatus and a system operating according to various embodiments.

### DETAILED DESCRIPTION

MIMO system techniques can multiply the effective data rate of a wireless local area network (WLAN) by nearly as many times as the number of antennas employed by an access point (AP) without the need for increased spectrum usage. MIMO systems exploiting channel state information (CSI) at the transmitter have the potential to reduce receiver complexity while achieving increased channel capacity. Common examples of such techniques include transmit beamforming (e.g., singular value decomposition or SVD), adaptive bit loading (ABL), and power allocation (e.g., tone puncturing). Sometimes relevant CSI cannot be obtained directly via training, because training symbol measurements are the aggregate response of several components, including the transmit chain response of the transmitting device, the wireless channel response, and the receive chain response of the receiving device. Therefore, accurate measurements of the wireless channel response may be assisted by calibration.

CSI at the transmitter may be obtained by having the transmitter send training symbols to a receiver, and then feeding back receiver measurements of the received channel response to the transmitter. Unfortunately, this time-consuming feedback process does not lend itself to situations where high throughput is desired, such as when various forms of the Institute of Electrical and Electronics Engineers (IEEE) 802.11 protocols are employed, including those considered by the High Throughput (HT) Study Group. For example, the round-trip channel responses of 2-by-2 and 4-by-4 MIMO systems using such feedback typically require 62 μs and 247 μs, respectively, at a 54 Mbps channel data rate. For more information on the IEEE 802.11 standards, please refer to “IEEE Standards for Information Technology—Telecommunications and Information Exchange between Systems—Local and Metropolitan Area Network—Specific Requirements—Part 11: Wireless LAN Medium Access Control (MAC) and Physical Layer (PHY), ISO/IEC 8802-11: 1999” and related amendments.

Thus, in many embodiments of the invention, mechanisms are disclosed that do not require CSI feedback from the receiver. In some embodiments, calibration schemes attempt to provide a ratio of transmit chain gain to corresponding receive chain gain that is substantially constant for each antenna, at both the transmitter and the receiver. In some embodiments, calibration on one side (i.e., a transmitter or receiver) and channel estimation on the other side (i.e., the corresponding receiver or transmitter) can be accomplished in a substantially simultaneous fashion using the same sets of symbols, or preambles. According to one example implementation, training symbols may well be embedded in, or concatenated to backward-compatiaable protocols using, e.g., existing RTS/CTS (request-to-send/clear-to-send) symbols or messages may be used (e.g., IEEE 802.11 and related amendments), although the invention is not limited in this respect. Thus, in many embodiments of the invention, calibration and training, including channel estimation, at both the transmitter and receiver may be accomplished during an exchange of content (e.g., symbols) generated for some purpose other than the exchange of training symbols (e.g., RTS/CTS symbols), eliminating the need for explicit CSI feedback. In other embodiments, the training symbol(s) may well be embedded within or concatenated to any packet(s), symbol(s) or message(s) that are generated for other purposes (i.e., non-training, or calibration purposes). As used herein, a “symbol” or “training symbol” may include any character, symbol, or message known to a receiver, including, for example, preambles, such as the long and short preambles defined with respect to an IEEE 802.11 a standard packet.

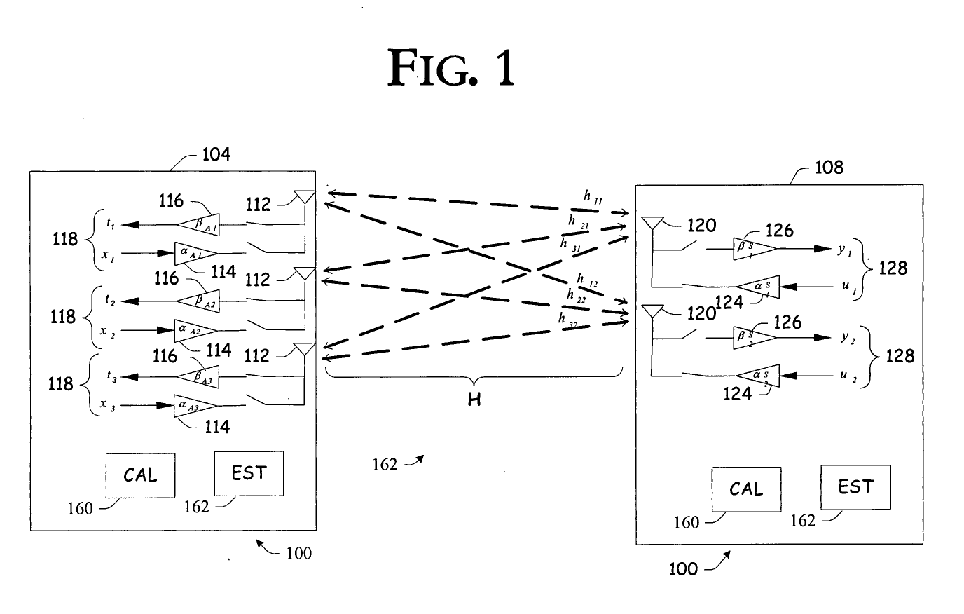

FIG 1 is a block diagram of apparatus 100 and a system 102 operating according to various embodiments. In the system 102, a first device 104, such as an access point (AP) or station (STA) may communicate with a second device 108, such as a STA or AP. The first device 104 may have a plurality of antennas 112 (e.g., three antennas 112), with one or more transmit chains 114 and one or more receive chains 116 coupled to each antenna 112. Each transmit chain 114-receive chain 116 pair may be included in a communication chain 118. The second device 108 may also have a plurality of antennas 120 (e.g., two antennas 120), where each antenna 120 also may be coupled to one or more transmit chains 124 and/or one or more receive chains 126. Each transmit chain 124-receive chain 126 pair may be included in a communication chain 128. Each transmit chain 114, 124 in one device 104, 108, respectively, may send training and calibration symbols to all receive chains 126, 116 included in another device 108, 104, respectively. For the purposes of this disclosure, the term “transceiver” (e.g., a device including a transmitter and a receiver) may be used in place of either “transmitter” or “receiver” throughout this document, and a transceiver may be included in a transmit chain and/or a receive chain.

Some communication systems may employ CSI, which may be acquired by receiving symbols, including preambles. However, as noted previously, the measurements of received preambles may include more than just the response of the wireless channel. For example, such measurements may include the combined responses of the transmit chains sending the preambles, the wireless channel, and the receive chain receiving the preambles. Thus, in some MIMO downlinks, the beamforming matrix can be affected by the combined responses of the transmit chains of the AP, the wireless channel, and the receive chains of the STA. In some cases, the chain responses of the STA may not be available to the AP.

In some embodiments, based on the preambles sent by the station, the device 104 can estimate the aggregate channel matrix from the input of the device 108 transmit chains 124 to the output of the device 104 receive chains 116 for the n-th subcarrier as shown in Equation (1):

$${H}_{u} = [ \begin{matrix}{β}_{A1} & 0 & 0 \\ 0 & {β}_{A2} & 0 \\ 0 & 0 & {β}_{A3}\end{matrix} ] \underbrace{[ \begin{matrix}{h}_{11} & {h}_{12} \\ {h}_{21} & {h}_{22} \\ {h}_{31} & {h}_{32}\end{matrix} ]}_{H} [ \begin{matrix}{a}_{S1} & 0 \\ 0 & {a}_{S2}\end{matrix} ] \qquad ( 1 )$$

where H is the wireless channel matrix for the uplink; β_{A1}, β_{A2} and β_{A3} are the responses of the device 104 receive chains 116; and α_{S1} and α_{S2} are the responses of the transmit chains for the device 108. The subcarrier index, n, has been omitted for simplicity. It should be noted that H may not be observed by the device 104, although it may be contained within Hᵤ, where Hᵤ is the measurement of the received training symbols (e.g., preambles). However, even when H is not available directly, in some embodiments, the matrix Hᵤ may be used without further processing.

For example, consider the prior art, where transmit beamforming (including techniques such as SVD and SDMA) may utilize explicit feedback from the receiver. For medium size packets, including those having about 500 bytes, feedback overhead can reduce physical layer efficiency by more than 40%. Thus, in various embodiments, reducing or removing feedback can significantly improve physical layer efficiency. To effect such a mechanism, several backward compatible protocols will be described, employing the exchange of existing RTS/CTS symbols, as well as various calibration techniques, some of which operate to adjust transmit/receive chain power and gain levels so that the ratio of a transmit gain to the corresponding receive gain comprises two constants (one for each device 104 antenna 112, and the other for each device 108 antenna 120).

Given the parameters established in Equation (1), the signals received at the device 108 from the device 104 in the downlink of FIG. 1 may be illustrated by Equation (2) below:

$$[ \begin{matrix}{y}_{S1} \\ {y}_{S2}\end{matrix} ] = \underbrace{[ \begin{matrix}{β}_{S1} & 0 \\ 0 & {β}_{S2}\end{matrix} ] [ \begin{matrix}{h}_{11} & {h}_{21} & {h}_{31} \\ {h}_{12} & {h}_{22} & {h}_{32}\end{matrix} ] [ \begin{matrix}{α}_{A1} & 0 & 0 \\ 0 & {α}_{A2} & 0 \\ 0 & 0 & {α}_{A3}\end{matrix} ]}_{{H}_{d}} [ \begin{matrix}{x}_{{A1}^{5}} \\ {x}_{A2} \\ {x}_{A3}\end{matrix} ] \qquad ( 2 )$$

where yₛ₁ and yₛ₂ signify the received signal at the output of the device 108 receive chains 126; x_{A1}, x_{A2}, and x_{A3} are the symbols sent to the device 108; α_{A1}, α_{A2} and α_{A3} are the device 104 transmit chain 114 gains; and, β_{S1} and β_{S2} are the device 108 receive chain 126 gains. As a matter of contrast, the signals received at the device 104 from the device 108 in the uplink may be illustrated by Equation (3) below:

$$[ \begin{matrix}{y}_{A1} \\ {y}_{A2} \\ {y}_{A3}\end{matrix} ] = \underbrace{[ \begin{matrix}{β}_{A1} & 0 & 0 \\ 0 & {β}_{A2} & 0 \\ 0 & 0 & {β}_{A3}\end{matrix} ] [ \begin{matrix}{h}_{11} & {h}_{12} \\ {h}_{21} & {h}_{22} \\ {h}_{31} & {h}_{32}\end{matrix} ] [ \begin{matrix}{α}_{S1} & 0 \\ 0 & {α}_{S2}\end{matrix} ]}_{{H}_{u}} [ \begin{matrix}{x}_{S1} \\ {x}_{S2}\end{matrix} ] \qquad ( 3 )$$

where x_{S1} and x_{S2} are the symbols sent to the device 104; y_{A1}, y_{A2}, and y_{A3} are the signals received at the output of the device 104 receive chains 116; α_{S1} and α_{S2} are the device 108 transmit chain 124 gains; and β_{A1}, β_{A2} and β_{A3} are the device 104 receive chain 116 gains.

Two aggregate channels, H_{d} and Hᵤ, may be defined as shown in Equations (2) and (3). If the aggregate channels H_{d} and Hᵤ maintain reciprocity, (i.e., H_{d}=Hᵤ^{T}), the estimated aggregate channel may be employed without decomposition to perform transmit beamforming.

A sufficient condition for reciprocity may be shown in Equations (4) and (5) as follows:

$$\begin{matrix}\frac{{α}_{A1}}{{β}_{A1}} = \frac{{α}_{A2}}{{β}_{A2}} = \frac{{α}_{A3}}{{β}_{A3}} = {c}_{n} & ( 4 ) \\ \frac{{α}_{S1}}{{β}_{S1}} = \frac{{α}_{S2}}{{β}_{S2}} = {b}_{n} & ( 5 )\end{matrix}$$

where cₙ and ₙ are two constants for the n-th subcarrier. To satisfy the condition of reciprocity exactly, cₙ may be set equal to bₙ. However, in many embodiments, it may be sufficient that H_{d}=kₙHᵤ^{T}, where H_{d} and Hᵤ^{T} differ by the product of a scalar kₙ. To satisfy the conditions set by Equations (4) and (5) then, calibration and compensation may be effected at device 104 and device 108. Two exemplary schemes that may be used to achieve these conditions are described next.

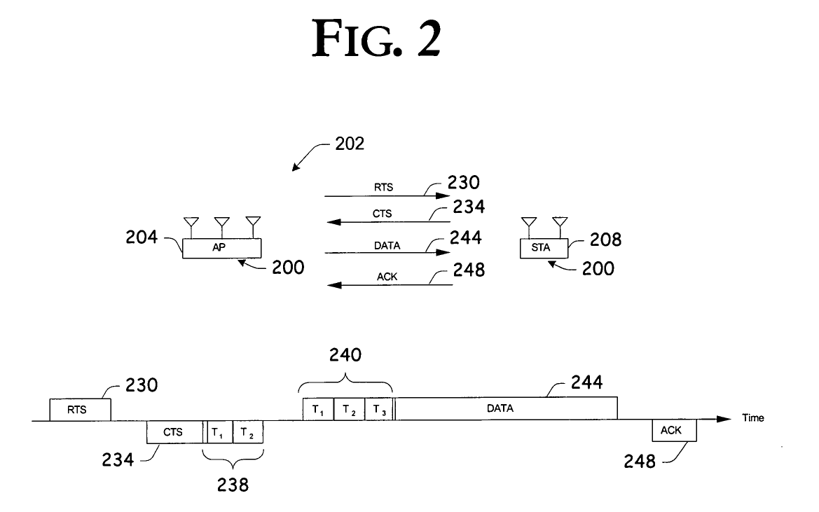

FIG. 2 is a block diagram of apparatus 200 and a system 202 operating according to various embodiments. Each device 204, 208 (which may be similar to or identical to devices 104, 108, respectively, as shown in FIG. 1, and may include an AP and/or a STA) may have multiple transmit power control (TPC) levels and multiple receive gain control levels, including automatic gain control (AGC) levels, for each of the included communication chains. Further, transmit and receive responses, α and β, may vary with selected TPC and AGC settings. Thus, implementing a series of training exchanges for each possible combination of TPC and AGC (e.g., when there is no prior information about the desired setting) may be time-consuming if there are a large number of combinations. However, as explained hereinbelow, in various embodiments, desired combinations of TPC and AGC settings may be established relatively quickly with respect to the devices 204, 208, such that calibration can occur rapidly.

In a first scheme, one device 204 may send one or more symbols 230, such as a request to transmit (e.g., a legacy RTS symbol or message) to the device 208 using a default TPC. Then, after the device 208 receives the transmitted symbol(s) (e.g., the RTS) 230, the device 208 may determine a set of desired AGC and TPC settings for the link to the device 204.

At this point, the device 208 may send a symbol 234 in response, such as a clear to transmit response (e.g., a legacy CTS symbol or message) and Nᵣ training symbols 238, where Nᵣ is the number of receive antennas (or RF chains) employed by the device 208, which may use the same Nᵣ antennas to receive one or more MIMO modulated data packets. The Nᵣ symbols 238, which may be used for training, can be sent in turn by each one of the Nᵣ antennas, perhaps using one symbol per antenna.

After the device 204 receives the response 234 (e.g., the CTS symbol), the device 204 may determine a set of desired AGC and TPC settings for the link to the device 208. Reception of the Nᵣ training symbols 238 may be used by the device 204 to estimate the Nₜ×Nᵣ channel, which may be a MIMO channel, where Nₜ is the number of transmit antennas (or RF chains) included in the device 204. The device 204 may use the same Nₜ antennas for channel estimation and data transmission, including MIMO data transmission. The Nᵣ training symbols 238 received by the device 208 may also be used to calibrate the communication chains (e.g., chains 128 shown in FIG. 1) included in the device 208 for the newly determined set of TPC and AGC settings.

The device 204 may subsequently transmit Nₜ training symbols 240 and data 244, including MIMO modulated data, to the device 208. The Nₜ training symbols 240 may be sent by Nₜ antennas (or RF chains), perhaps using one symbol per antenna at a desired TPC setting. The device 204 may receive the Nₜ training symbols 240 at a set of desired AGC settings and calibrate the communication chains included in the device 204 (e.g., chains 118 in FIG. 1). The communication chains included in the device 208 may likewise be calibrated after transmission of the Nᵣ training symbols 238. Beamforming, perhaps as a form of MIMO or SDMA system modulation, may be performed by the device 204 with respect to data sent by the device 204 to the device 208 using the channel information obtained as a result of receiving the response 234 from the device 208.

During reception of the Nₜ training symbols 240, the device 208 may set a desired AGC level and perform channel estimation. The resulting channel estimates may permit the device 208 to demodulate beamformed data provided by the device 204. After all data 244 has been received from the device 204, an acknowledgment 248 (e.g., a legacy ACK response) may be sent from the device 208 to the device 204 at a desired TPC setting.

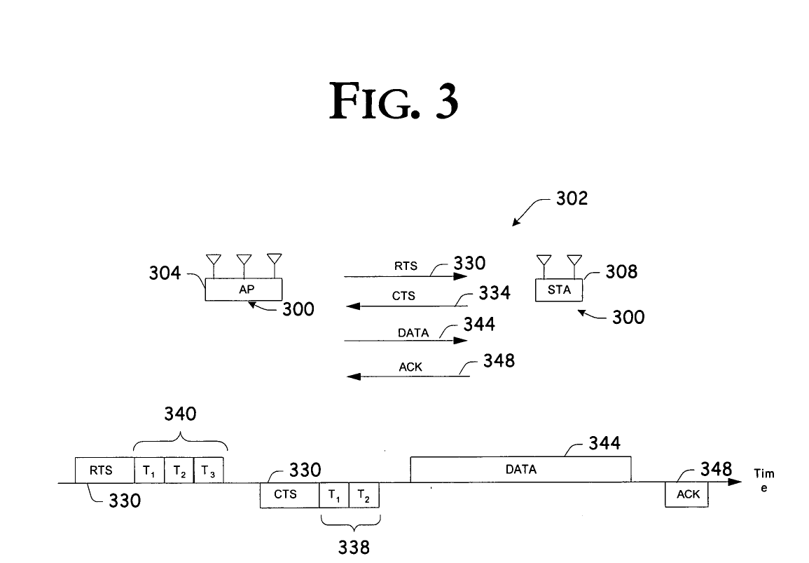

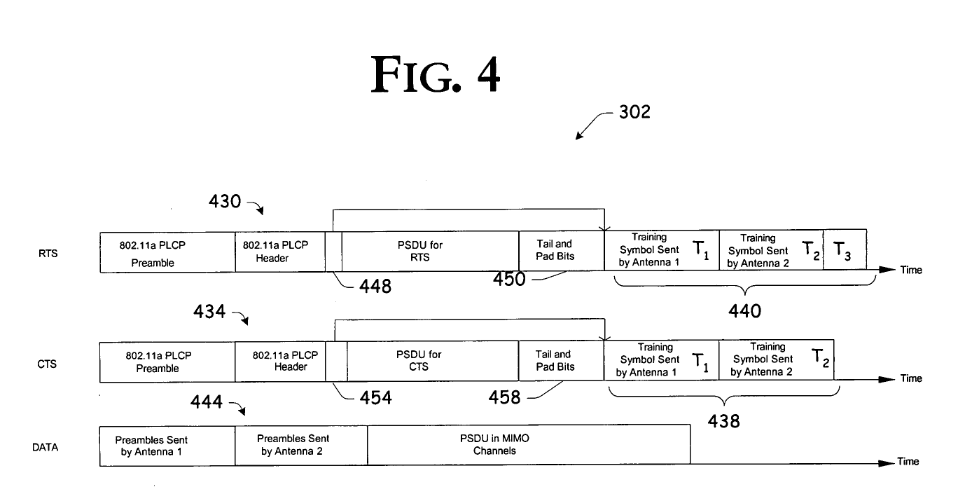

FIG. 3 is a block diagram of apparatus 300 and a system 302 operating according to various embodiments. Each device 304, 308 may be similar to or identical to devices 104, 108, respectively, shown in FIG. 1, and may include an AP and/or a STA. FIG. 4 is a block diagram of exemplary packet formats that can be utilized by the apparatus and system of FIG. 3.

In a second scheme, advantage is taken of the fact that, according to some implementations of the IEEE 802.11 standards, RTS and CTS symbols can be transmitted in such a way as to protect long data packets from collision. Thus, the Nₜ and Nᵣ training symbols may be attached directly to the request to transmit (e.g., legacy RTS) symbol and the clear to transmit response (e.g., legacy CTS) symbol, respectively, where Nₜ and Nᵣ are the number of antennas at the devices (or the number of communication chains), as described previously. In each case, the training symbols may be used to both calibrate the transmitter and enable the channel estimation of the receiver in one or more of the communication chains included in the apparatus 300.

Referring now to FIGS. 3 and 4, it can be seen that a device prepared to send data, for example, device 304, may transmit a symbol 330, 430 or packet, such as a legacy RTS packet, to another device, such as device 308. Nₜ training symbols 340 may be attached to the end of the packet 330, where Nₜ can be the number of transmit chains included in the device 304. The length field 448 in the packet 330, 430 may be set to protect up to the end of the pad bits 450, as specified in the IEEE 802.11 standard for legacy RTS packets. Thus, a legacy device may receive the RTS packet 330, 430 correctly and perform collision avoidance operations as needed.

The Nₜ symbols 340 may be sent in turn by the Nₜ communication chains included in the device 304. A calibration algorithm may be performed as the Nₜ symbols 340 are sent to calibrate both the transmit and the receive chains of the device 304. The device 308 receiving the Nₜ symbols 340, 440 and the symbol 330, 430 may estimate the associated channels and compute demultiplexing matrices to enhance data reception, as is known to those of ordinary skill in the art.

In some embodiments, calibration of M transmit/receive or communication chains at either of the devices 304, 308 may occur in such a way as to satisfy the criterion set by Equation (4). First, a training symbol x₀ for the n-th sub-carrier may be sent using a first transmit chain (e.g., transmit chain #1), and the output of a second receive chain (e.g., receive chain #2) may be measured. The measured output may be characterized by t₁₂=α_{A1}C₁₂β_{A2}x₀, where C₁₂ is the response from the input of a first antenna (e.g., antenna #1 coupled to transmit chain #1) to the output of a second antenna (e.g., antenna #2 coupled to receive chain #2).

Second, a training symbol x₀ for the n-th sub-carrier may be sent using a second transmit chain (e.g., transmit chain #2), and the output of a first receive chain (e.g., receive chain #1) may be measured. The measured output may be characterized by t₂₁=α_{A2}C₂₁β_{A1}x₀, where C₂₁ is the response from the input of the second antenna to the output of the first antenna.

Third, the variables α_{A1}, α_{A2}, β_{A1} and β_{A2} may be adjusted so as to render t₁₂=t₂₁. In some cases, this may be accomplished by changing only the variable β_{A2}. The adjustments of the chain gains can be implemented in the digital domain, if desired. After compensation is effected in this manner, the result should be:
α_{A1}C₁₂β_{A2}x₀=α_{A2}C₂₁β_{A1}x_{0 tm (}6)
Equation (6) may be simplified as follows, since C_{12=C}₂₁ due to reciprocity:

$$\frac{{α}_{A1}}{{β}_{A1}} = \frac{{α}_{A2}}{{β}_{A2}} \qquad ( 7 )$$

At this point, a loop may be executed with respect to the remaining communication chains, that is, for i=3, . . ., M. Each execution of the loop may involve sending a training symbol x₀ for the n-th sub-carrier using the first transmit chain and measuring the output of receive chain i. The measured output, characterized by tₗᵢ=α_{A1}Cₗᵢβ_{Ai}x₀, where Cₗᵢ may be seen as the response from the input of the first antenna to the output of antenna i. Then loop execution may involve sending a training symbol x₀ for the n-th sub-carrier using transmit chain i, and measuring the output of the first receive chain. The measured output may be characterized as tᵢₗ=α_{Ai}Cᵢₗβ_{Al}x₀, where Cᵢₗ can be seen as the response from the input of antenna i to the output of the first antenna.

Finally, the variables α_{Ai} and β_{Ai} may be adjusted so as to render tₗᵢ=tᵢₗ. Again, in some cases, this may be accomplished by changing only the variable β_{Ai}. The adjustments of the communication chain gains may be implemented in the digital domain, if desired. After compensation is effected in this manner, the result may be:
α_{A1}Cₗᵢβ_{Ai}x₀=α_{Ai}Cᵢₗβ_{Al}x₀ (8)
Since Cₗᵢ=Cᵢₗ due to reciprocity, Equation (8) may be simplified as follows:

$$\frac{{α}_{A1}}{{β}_{A1}} = \frac{{α}_{Ai}}{{β}_{Ai}} \qquad ( 9 )$$

The loop may be repeated for each value of i in this manner until all of the chains M have been calibrated.

According to one embodiment, variations of the process in block 28 and 29 are anticipated. For example, after a first calibration between chain 1 and 2 (e.g., Eq. (7)), chain 2 may be used to perform the calibration with chain 3 (i.e., not chain 1). In other words, the subscript 1, may be replaced with any “i” such that chain i has been calibrated. When one chain is sending a calibration symbol, the remaining chains within the same device can receive it and perform calibrations, substantially simultaneously. In this regard, the calibration “loop” of blocks 28 and 29 may be shortened.

The device 308 receiving the symbol 330 may respond by sending another symbol (or symbols, and/or packets, such as a legacy CTS symbol). This transmission may occur if the status of a network allocation vector (NAV) indicates the channel is idle. Nᵣ training symbols 338, 438 may be attached to the end of the symbol or packet 334, 434, where Nᵣ is the number of the receive chains included in the device 308. The Nᵣ symbols 338, 438 may be sent in turn by Nᵣ antennas coupled to the receive chains included in the device 308 to receive data packets 344, 444. As noted above, the length field 454 in the packet 334, 434 may be set to protect up to the end of the pad bits 458, as specified in the IEEE 802.11 standard for legacy CTS packets. Thus, a legacy device may receive the CTS packet 334, 434 correctly and perform collision avoidance operations as needed.

As described above, a calibration algorithm may be performed as the Nᵣ symbols 338, 438 are sent, in order to calibrate the transmit and the receive chains included in the device 308. In turn, the device 304 receiving the Nᵣ symbols 338, 438 and the response symbol 334, 434 (e.g., a legacy CTS packet) may estimate the associated channels and determine beamforming matrices for transmission of the data 344, 444.

The device 304 may then send the data 344, 444 using transmit beamforming, adaptive bit loading, and/or power allocation techniques, as is known to those of skill in the art. A symbol of acknowledgment (e.g., a legacy ACK symbol or packet) 348 may be received by the device 304 after the data 344, 444 is sent.

Upon reading this disclosure, those of skill in the art will realize that the device 308 receiving the request to send 330, 430 symbol or packet may estimate the channel matrix (e.g., for each orthogonal frequency division multiplexing (OFDM) tone) and form a corresponding demultiplexing matrix (e.g., the “U” matrix in SVD techniques) by exploiting the attached training symbols 340, 440. Since channel estimation and matrix computation are completed beforehand, the preambles at the beginning of the data packet 344, 444 may be used only for synchronization, and may not be needed for channel estimation. Thus, since the preambles of the data 344, 444 are used only for synchronization, they may be shortened. Similarly, upon reading this disclosure, those of skill in the art will realize that the device 304 receiving the clear to send response 334, 434 symbol or packet may also estimate the associated channel and compute a beamforming matrix (e.g., the “V” matrix in SVD techniques) by exploiting the attached training symbols 338, 438.

Thus, referring now to FIGS. 1, 2, and 3, it can be seen that an apparatus 100, 200, 300 may be similar to or identical to the devices 104, 108, 204, 208, and 304, 308, including devices such as an AP and/or STA. Such apparatus 100, 200, 300 may therefore include a device 104, 204, 304 having a first number of communication chains 118 to transmit to a second apparatus 100, 200, 300 or device 108, 208, 308 a first number of training symbols corresponding to the first number of communication chains 118 and to solicit a response from the second apparatus 100, 200, 300 or device 108, 208, 308 including a second number of training symbols corresponding to a number of communication chains 128 included in the second device 108, 208, 308.

The first number of communication chains 118 may correspond to a number of transmit chains 114, and the second number of communication chains 128 may correspond to a number of receive chains 126. Similarly, the first number of communication chains 118 may correspond to a number of receive chains 116, and the second number of communication chains 128 may correspond to a number of transmit chains 124. The apparatus 100, 200, 300 may include a calibration module 160 to calibrate the transmit chains 114, 124 and/or the receive chains 116, 126. The apparatus 100, 200, 300 may also include an estimation module 162 to estimate one or more channels associated with the number of receive chains 116, 126.

A system 102, 202, 302 may include a first apparatus 100, 200, 300 or device 104, 204, 304, similar to or identical to those described previously. The system 102, 202, 302 may also include a second apparatus 100, 200, 300 or device 108, 208, 308, similar to or identical to those described previously. The first apparatus 100, 200, 300 or device 104, 204, 304 may include a number of communication chains 118 to transmit a number of training symbols corresponding to the number of communication chains 118 to the second device 108, 208, 308. In turn, the second apparatus 100, 200, 300 or device 108, 208, 308 may include a number of communication chains 128 to receive the training symbols from the first device 104, 204, 304, and may respond by transmitting to the first device 104, 204, 304 a number of training symbols corresponding to the number of communication chains 128.

The system 102, 202, 302 may include a first number of antennas 112 corresponding to a first number of communication chains 118, and a second number of antennas 120 corresponding to a second number of communication chains 128. The system 102, 202, 302 may also include one or more calibration modules 160 to calibrate the communication chains 118, 128, as well as one or more estimation modules to estimate one or more channels associated with the communication chains 118, 128. In some embodiments, the communication chains 118, 128 may be capable of being coupled to a number of antennas 112, 120 to form a portion of a multiple-input, multiple-output (IMO), or SDMA system.

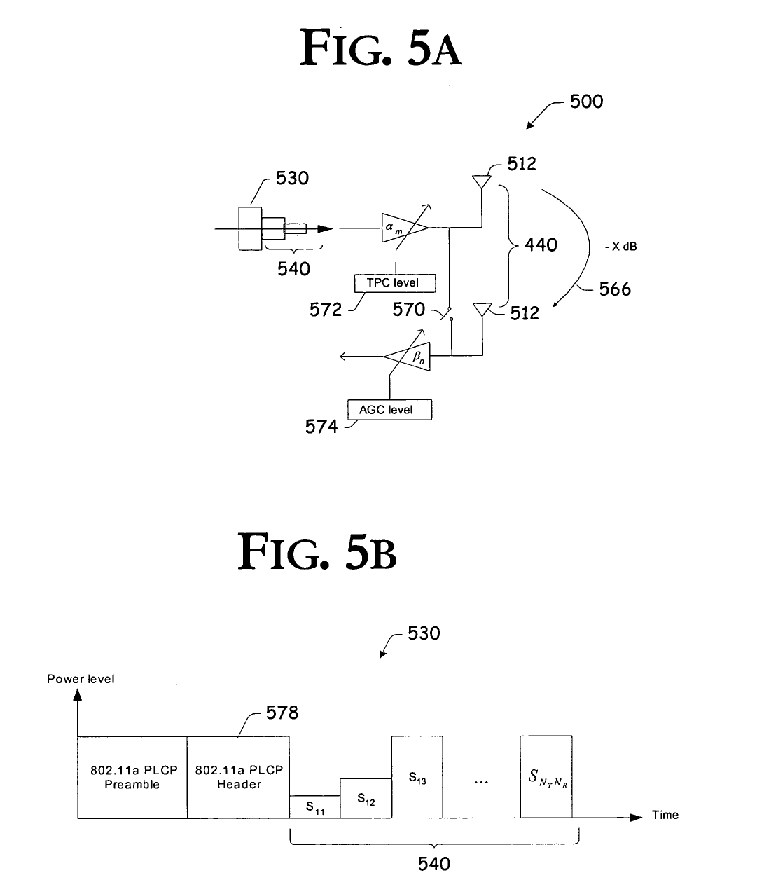

FIGS. 5A and 5B are a block diagram of an apparatus 500 operating according to various embodiments, as well as an exemplary packet format which may be implemented thereby, respectively. Calibration of the apparatus 100, 200, 300 and devices 104, 108, 204, 208, 304, 308 may be accomplished in many ways other than those described with respect to the first and second schemes explicitly described herein. For example, with respect to the second scheme outlined above, since some apparatus 500 (which may be similar to or identical to apparatus 100, 200, 300 and/or devices 104, 204, 304 and devices 108, 208, 308) periodically operate in a sleep mode, calibration may sometime be accomplished during this mode, such as after the apparatus 500 announces an upcoming sleep period. The apparatus 500 may include a communication chain 518.

In such circumstances, calibration may begin with sending a symbol or packet 530 from the apparatus 500 to the apparatus 500 itself (i.e., self-calibration). Then calibration and/or training symbols 540 can also be sent from and to itself. This type of calibration can be accomplished using antennas 512 and on-air signals 566, or via an internal switching network 570. On-air calibration may provide increased accuracy, but it may also generate interference. Use of the switching network 570 may reduce accuracy due to mismatch among switches.

Transmit gains (β_{Ai} and β_{Si}) may vary with the TPC setting 572. Similarly, receive gains (α_{Ai} and α_{Si}) may vary with the gain control setting 574, such as the AGC setting. Therefore, calibration may be used to find a set of values for one chain (typically a number of receive gain settings) for each pair of TPC and AGC settings on other chains. Assuming there are N_{T} and N_{R} levels for TPC and AGC respectively, then a compensation and calibration algorithm may step through all N_{T}×N_{R} settings. Gains may be selected independently of actual transmit and receive signal magnitudes.

To accomplish compensation and calibration in the sleep mode, then, an apparatus 500 may begin by announcing a coming sleep period. This announcement may be asserted by setting a value in an associated power management field of a frame. Then, for i=1, . . . , N_{T} a loop involving the following activities may be entered: set the TPC to level i for all transmit chains, then loop j times for j=1, . . . , N_{R}, setting the AGC to level j for all receive chains except chain i, sending training symbols (e.g., OFDM training symbols) having a magnitude to optimize the received signal-to-noise ratio (SNR) without saturation in the receive chains while minimizing interference with other devices. These activities may be followed with calibrating as described for the second scheme above.

As shown in FIG. 5B, the training symbols 540 may be sent in a packet format to prevent nearby devices (e.g., other AP or STA devices) from interfering with calibration for the apparatus 500. For example, the packet length field in the physical layer convergence protocol (PLCP) header 578 may be used to indicate to nearby devices that calibration is in effect, and to prevent them from transmitting during that time. Training symbols 540 may be included in the data portion of the packet 530, where Sᵢⱼ is the training symbol for TPC setting i and AGC setting j. The packet 530 may be addressed to the device 500 itself.

Path loss between two calibrating antennas 512 coupled to the same apparatus 500 may be about 30-40 dB, and the path loss between two apparatus 500 or devices may be about 60-90 dB. Therefore, devices not in calibration mode should be able to operate while other devices are engaged in self-calibration. However, in some cases non-calibrating devices may interfere with self-calibrating devices, because calibration and training AGC levels may be set to normal operating levels, so that interfering signals have about the same level as training signals. Such difficulties may be resolved by sending additional calibration packets during the sleep mode, since the time spent in sleep mode by some apparatus 500 may be much longer than the time spent in active mode.

The apparatus 100, 200, 300, 500, systems 102, 202, 302, devices 104, 108, 204, 208, 304, 308, antennas 112, 120, 512, transmit chains 114, 124, receive chains 116, 126, communication chains 118, 128, 518, symbols 230, 234, 238, 240, 430, 434, 438, 440, 530, 540, data 244, 444, fields 448, 454, bits 450, 458, calibration module 160, estimation module 162, on-air signals 566, switching network 570, TPC setting 572, gain control setting 574, and PLCP header 578 may all be characterized as “modules” herein. Such modules may include hardware circuitry, and/or one or more processors and/or memory circuits, software program modules, including objects and collections of objects, and/or firmware, and combinations thereof, as desired by the architect of the apparatus 100, 200, 300, 500 and the systems 102, 202, 302, and as appropriate for particular implementations of various embodiments.

It should also be understood that the apparatus and systems of various embodiments can be used in applications other than transmitters and receivers, and other than for wireless systems, and thus, various embodiments are not to be so limited. The illustrations of apparatus 100, 200, 300, 500 and systems 102, 202, 302 are intended to provide a general understanding of the structure of various embodiments, and they are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, processor modules, embedded processors, data switches, and application-specific modules, including multilayer, multi-chip modules. Such apparatus and systems may further be included as sub-components within a variety of electronic systems, such as televisions, cellular telephones, personal computers, personal digital assistants (PDAs), workstations, radios, video players, vehicles, and others.

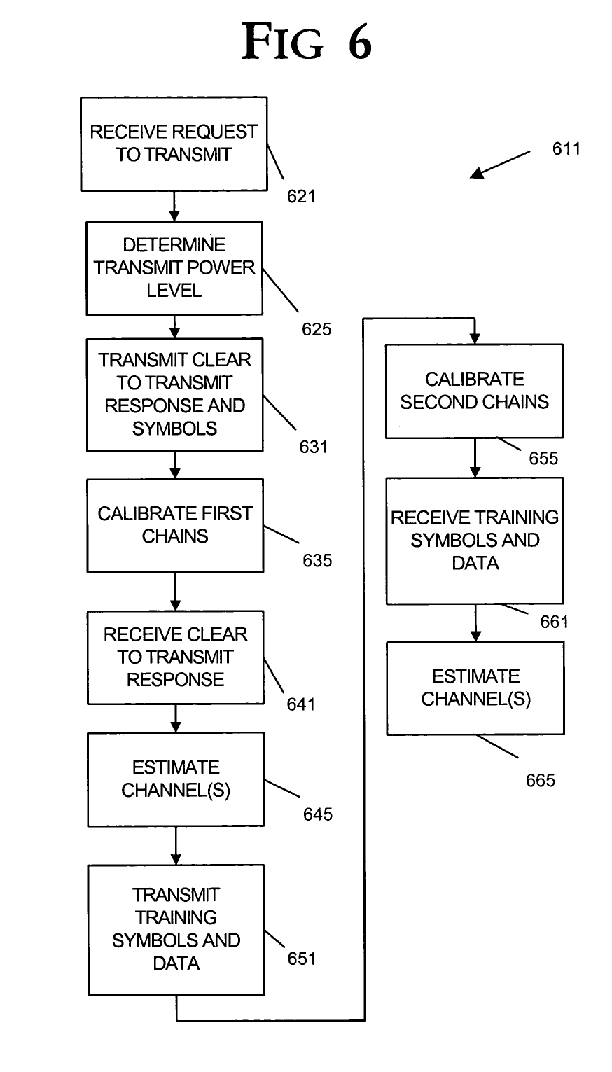

FIG. 6 is a flow chart illustrating several training and calibration methods according to various embodiments. With respect to this figure, it should be noted that any of the numbers of communication chains discussed may correspond to a number of receive chains, and/or to a number of transmit chains, as desired for particular implementations of the method 611. Therefore, in light of the previous discussion with respect to the first scheme, it can be seen that a method 611 directed to the operation of various embodiments embodiments of the invention disclosed may (optionally) begin with receiving a request to transmit at a first number of communication chains at block 621 and determining one or more transmit power levels and/or receive gain levels associated with the first number of communication chains at block 625. The method 611 may include transmitting a clear to transmit response and a first number of training symbols from the first number of communication chains at block 631 and calibrating some number of transmit and receive chains included in the first number of communication chains at block 635. Thus, the method 611 may include transmitting a first number of training symbols corresponding to a first number of communication chains to solicit a response including a second number of training symbols corresponding to a second number of communication chains.

The method 611 may continue with receiving a clear to transmit response and the first number of training symbols at a second number of communication chains at block 641 and estimating one or more communications channels associated with the second number of communication chains based on the first number of training symbols at block 645. The method 611 may also include transmitting the second number of training symbols and data at block 651. Thus, the method 611 may include transmitting a second number of training symbols corresponding to a second number of communication chains in response to receiving a first number of training symbols corresponding to a first number of communication chains.

The method 611 may include calibrating some number of transmit and receive chains included in the second number of communication chains based on the second number of training symbols at block 655. The method 611 may continue with receiving the second number of training symbols and data at block 661 and estimating one or more communications channels associated with the first number of communication chains based on the second number of training symbols at block 665.

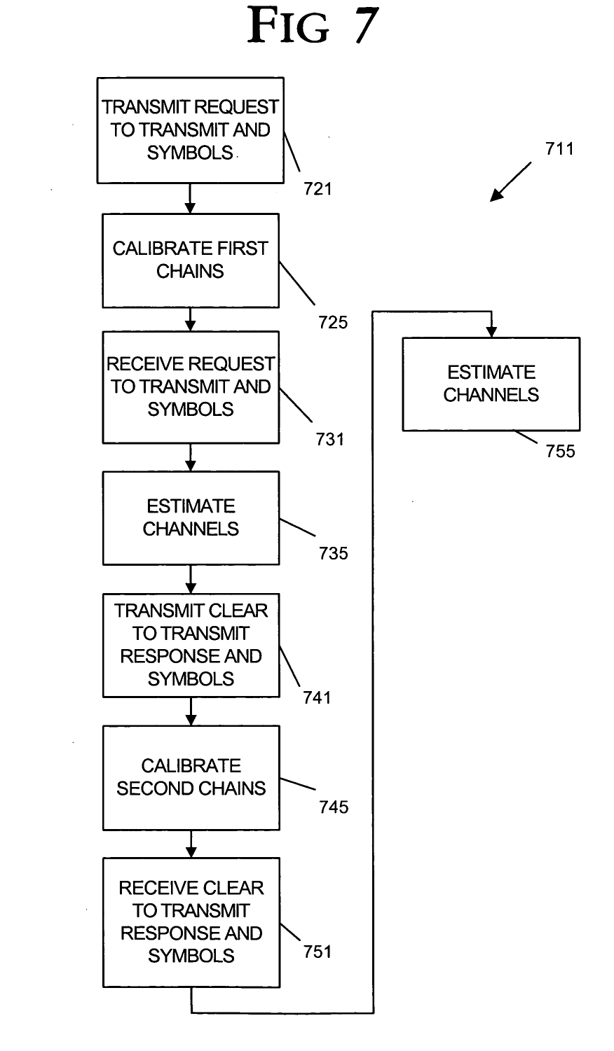

FIG. 7 is a flow chart illustrating several alternative training and calibration methods according to various embodiments. With respect to this figure, it should be noted that any of the numbers of communication chains discussed. may correspond to a number of receive chains, and/or to a number of transmit chains, as desired for particular implementations of the method 711. Therefore, in light of the previous discussion with respect to the second scheme, it can be seen that a method 711 directed to the operation of various embodiments of the invention disclosed may (optionally) begin with transmitting a request to transmit and the first number of training symbols at block 721 and calibrating one or more of the first number of communication chains at block 725. Calibrating the first number of communication chains may occur during a sleep mode. The method 711 may also include transmitting a header including a length specification corresponding to the first number of training symbols. Thus, the method 711 may include transmitting a first number of training symbols corresponding to a first number of communication chains to solicit a response including a second number of training symbols corresponding to a second number of communication chains.

The method 711 may continue with receiving a request to transmit and the first number of training symbols at block 731 and estimating one or more channels associated with the second number of communication chains at block 735. The method 711 may include transmitting a clear to transmit response and the second number of training symbols at block 741 and calibrating one or more of the second number of communication chains at block 745. Calibrating the second number of communication chains may occur during a sleep mode. Thus, the method 711 may include transmitting a second number of training symbols corresponding to a second number of communication chains in response to receiving a first number of training symbols corresponding to a first number of communication chains.

The method 711 may continue with receiving a clear to transmit response and the second number of training symbols at block 751 and estimating one or more channels associated with the first number of communication chains at block 755. The method 711 may also include transmitting a header including a length specification corresponding to the second number of training symbols.

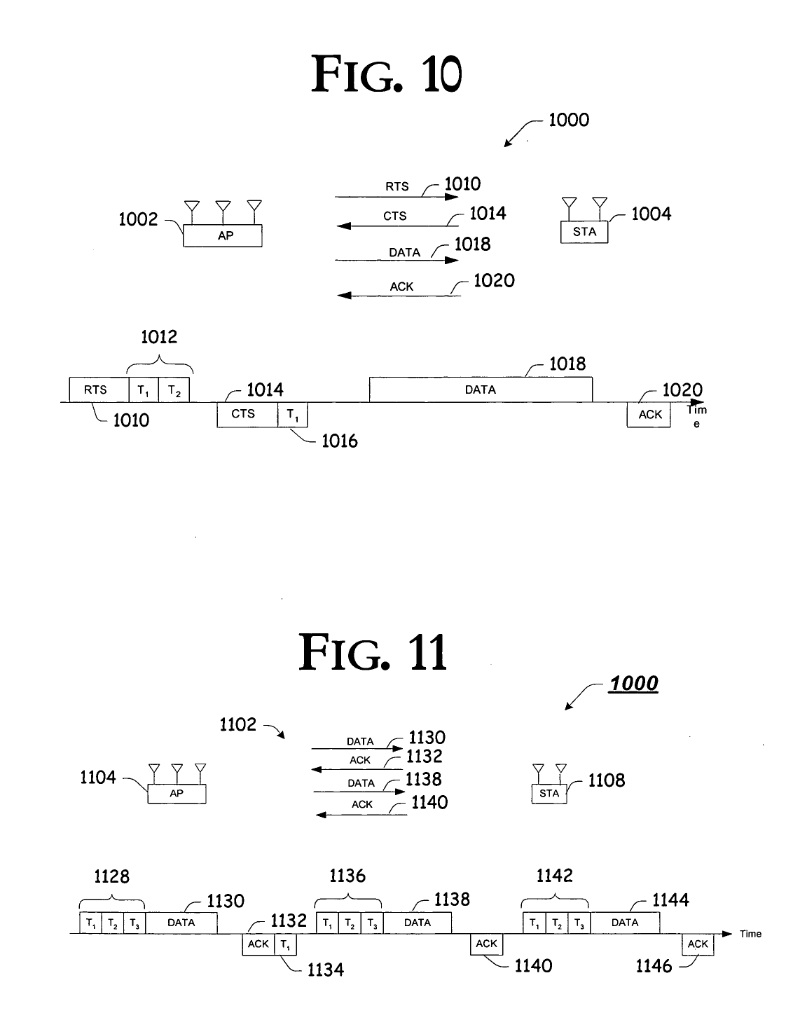

Turning now to FIGS. 9-12, additional embodiments of the inventive aspects of the invention are introduced. Recall from FIGS. 2 and 3, that training symbols were selectively embedded within, or characterized by, communication symbols conventionally used for other purposes (e.g., handshaking, acknowledgment, link negotiation, etc.). That is, rather than generating and issuing dedicated training symbols to effect training and calibration, we propose leveraging the transmission of “other” symbols, traditionally used for purposes other than training, in which to include training symbol(s), or as training symbols themselves. As described above, legacy handshaking packets (e.g., RTS/CTS) were but one example embodiment, wherein training symbols associated with each transmit antenna(e) were issued from both devices 204, 208. In FIGS. 9-11, this inventive concept is extended and modified to provide further reduction in communication overhead.

FIG. 9 is a block diagram of an example apparatus and a system operating according to various embodiments. As introduced above, an inventive aspect of the invention is that it leverages “known packets” such as, e.g., acknowledgment packets, clear to send (CTS) packets, and the like) as training symbols for training and/or calibration. The content of the known packet is known to the recipient to a high extent. For example, in a legacy system, the content of a CTS is known to an expected recipient, i.e. the sender of the RTS, except the only uncertainty is the code rate and modulation type used in the CTS packet. According to one example embodiment, the most accurate calibration and training results are achieved when performed on an antenna by antenna basis, i.e., when a symbol is sent from a single antenna at a time. In this regard, transmission from multiple antenna(e) is introduced wherein symbol transmission is sequentially stepped through at least a subset of the antenna(e), although the invention is not limited in this regard.

As introduced above, each device 902, 904 (which may be similar to or identical to devices 104, 108, respectively, as shown in FIG. 1, and may include an AP and/or a STA) may have multiple transmit power control (TPC) levels and multiple receive gain control levels, including automatic gain control (AGC) levels, for at least a subset of the included communication chains. Further, transmit and receive responses, α and β, may vary with selected TPC and AGC settings.

As shown, device 902 may send one or more symbols 908 such as a request to transmit (e.g., a legacy RTS symbol or message) to the device 904, e.g., using a default or previously determined TPC, although the invention is not limited in this regard. According to one aspect of the invention, the transmission 908 is sent via one or more antenna(e) predicted to provide the best (as compared to the other antenna options) signal characteristic (e.g., signal to noise ratio (SNR) at the receiving device (904). The determination of which antenna(e) to send symbol(s) 908 through may be made based on prior training, or predicted without training/calibration based on an estimate of channel conditions, although the invention is not limited in this regard.

In response to the received symbol (e.g., the RTS), the receiving device 904 may generate a response 910, e.g., a clear to send (CTS) symbol if/when appropriate, for transmission to device 902. According to one aspect of the invention, device 904 introduces a training symbol to the response 910. According to one aspect of the invention, the training symbol(s) may well be integrated within, or appended to the response 910. Unlike the system of FIG. 2 that utilized at least one training symbol for each of the transmit antenna(e), device 904 of FIG. 9 may select a mere subset of the available transmit antennae through which to transmit the response 910 and associated training symbol 912. As introduced above, the training symbol(s) 912 may well be integrated within, or appended to response 910. Utilizing the CTS 910 and training symbol 912, device 902 may perform channel estimations, while device 904 may perform calibration. According to one aspect of the present invention, the response 910 is sent from the antenna(e) which is perceived, or estimated, to provide the best signal characteristics at the receiving device (902), although the invention is not limited in this regard.

Upon receipt of the response from device 904, e.g., the CTS symbol, device 902 processes content (e.g., data) 916 for transmission to device 904. According to one embodiment, device 902 includes one or more training symbol(s) 914. In accordance with the illustrated example embodiment, device 902 includes at least one training symbol for each of the antenna(e) of device 902. According to one embodiment, the first training symbol (TI) of training symbols 914 is sent via the antenna identified as providing the best performance at the receiving device 904, although the invention is not limited in this regard.

According to one embodiment, upon receipt of data 916, device 904 issues an acknowledgement, e.g., an ACK symbol 918. Thus, embodiments of the invention limit the training/calibration overhead associated with managing a communication channel by reducing the number of training symbols utilized by the devices, and transmitting the training symbol from only a subset of the antenna(e) of the device identified to provide the best signal characteristics at the receiver, and that such training symbols may be embedded within, or appended to, any type of conventional transmission (e.g., a CTS symbol, a data symbol, etc.).

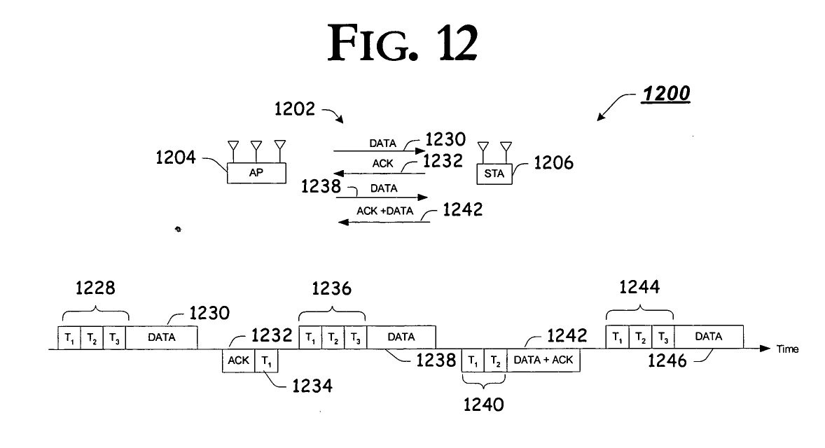

Turning to FIG. 10, a block diagram of an example apparatus and system according to embodiments of the invention is depicted. More particularly, an apparatus and system which combines the select transmission of training symbol(s) through a select subset of transmit antenna(e) using conventional data packets (e.g., RTS/CTS) is depicted. In this regard, the apparatus and system depicted in FIG. 10 may, in some embodiments, represent a combination of at least a subset of the inventive elements of FIGS. 3 and 9.

In FIG. 10, device 1002 generates a message 1010 for transmission to a remote device 1004. According to one embodiment, the message 1010 is a request to transmit (RTS) packet. According to one aspect of the invention, the message 1010 will be sent via the antenna perceived, or estimated, to provide the best performance at the receiving device 1004. According to one aspect of the invention, the number of training symbols 1012 and the antenna(e) from which they are sent are similarly selected from the remaining options by device 1002 to provide the best performance at the receiving device 1004. That is, since message 1010 will be sent from the antenna deemed to provide the best performance at receiving device 1004, the training symbols will be sent from the next best two antenna options, although the invention is not limited in this regard.

In accordance with conventional operation, the device 1004 receiving the RTS message will generate, a clear to send (CTS) response 1014 when it is, in fact, clear for device 1002 to continue with the transmission of data. According to one aspect of the invention, device 1004 takes the opportunity of issuing the CTS message 1014 to issue its own training symbol(s) 1016. Utilizing the CTS 1014 and training symbol 1016, device 1002 may perform channel estimations, and device 1004 may perform calibration. According to one aspect of the invention, the CTS 1014 is transmit from the antenna perceived, or estimated, by device 1004 to provide the best receive performance at device 1002. According to one aspect of the invention, the number of training symbols 1016 and the antenna(e) from which they are transmit are selected by device 1004 from the remaining options to provide the best receive performance at device 1002.

Upon receiving the CTS message, device 1002 proceeds with the transmission of data 1018. According to one embodiment, device 1002 selects the antenna(e) through which the data is transmit based, at least in part, on the channel information received/perceived as a result of receiving the training symbols 1016 from device 1004. In response to the receipt of data 1018, device 1004 issues an acknowledgement 1020.

Turning to FIG. 11, a block diagram of an example apparatus and system according to embodiments of the invention is presented. More particularly, FIG. 11 illustrates a training scheme that utilizes the transmission of data packets, and subsequent acknowledgements to selectively effect training of the devices 1104, 1108. According to one example embodiment, FIG. 11 presupposes that there may be a sequence of DATA-ACK exchanges between the devices 1104, 1108 because, e.g., device 1104 may have a lot of data packets to download to device 1108. Unlike the techniques introduced above that relied on conventional channel management packets (e.g., RTS/CTS) in which to transmit training symbols, the technique in FIG. 11 does not require initiation through an RTS/CTS exchange. Rather, as shown, training symbol(s) are selectively embedded within, or appended to, an otherwise conventional DATA-ACK transmission exchange.

As shown, the technique begins with device 1104 generating a data packet 1130 for transmission to device 1108. As shown, device 1104 will transmit the data packet 1130 to device 1108 with training symbols 1128 via each of the transmit antenna, although the invention is not limited in this regard.

In response to receipt of a data packet 1130, device 1108 generates an acknowledgment packet (ACK) 1132 for transmission to device 1104. According to one aspect of the invention, device 1108 generates one or more training symbol(s) 1134 to embed within, or append to, the ACK 1132. According to one aspect of the invention, the ACK 1132 may include information regarding the antenna with the best reception quality at device 1108, and one training symbol for each other antenna under two conditions: 1) device 1108 detects that device 1104 did not employ beamforming, or that any beamforming applied is not sufficiently accurate; and 2) device 1108 detects that more data is coming (from device 1104). According to one embodiment, the determination that additional data is coming may be identified from analysis of the received data packet 1130 (e.g., an indication embedded within a “more data” field of the received packet).

Using one antenna to send the ACK 1132 eliminates the need for one training symbol. Upon receiving the ACK 1132 and training symbol 1134, device 1104 performs channel training and determines an appropriate transmit power control (TPC) and auto gain control (AGC) levels, e.g., in accordance with one or more techniques introduced above, although the invention is not limited in this regard.

After device 1104 performs initial channel training, it may issue another data packet 1138. In accordance with the illustrated example embodiment, one or more training symbols 1136 may be embedded within, or appended to, data packet 1138. As shown, the number of training symbols, their order, and the antenna from which each is sent may be selected by device 1104 to provide improved channel training for the receiving device 1108 based, at least in part, on the initial channel training previously performed. In this regard, the training symbols 1136 may be longer than those previously sent. Using at least these symbols 1136, the device 1104 calibrates its transmit chains, while device 1108 may “perform channel estimations”. According to one aspect of the invention, insofar as device 1104 obtains both calibration and channel training, it may perform beamforming on the DATA 1138 portion of the second packet.

According to one aspect of the invention, device 1108 may well issue another training symbol along with the acknowledgment packet 1140, the purpose of which to allow device 1104 to estimate the channel again and track variation in the channel. According to one embodiment, such additional training symbol(s) may be sent if 1) device 1108 detects that additional data may be sent from device 1104, and/or 2) device 1108 detects a variation in the channel, although the invention is not so limited.

As shown, device 1104 may again issue training symbols 1142 along with a subsequent data packet 1144, although the invention is not limited in this regard. According to one aspect of the invention, device 1104 may issue the subsequent training symbols if: 1) it detects variation in its chains, e.g., from an internal analysis of the reverse link, or if it receives an acknowledgement packet with training symbols from the remote device 1108; and 2) device 1108 has additional data to transmit to device 1108, although the invention is not limited in this regard.

Turning now to FIG. 12, a block diagram of an example apparatus and system according to embodiments of the invention is depicted. More particularly, according to one example embodiment of the invention, FIG. 12 illustrates an example implementation which is an extension to the embodiment of FIG. 11 where, in responding to the receipt of data from a remote device (1204), a receiving device (1206) issues a data packet and an acknowledgment packet 1242. In this regard, to send data from device 1206 using beamforming, the device may utilize channel training symbol(s) (1232, 1234) previously sent to device 1204, e.g., in response to receipt of a first data packet (1230). According to one embodiment, the device may use a “piggy-back” mechanism to send the data 1242 as shown in FIG. 12, or it may use an ordinary data packet. According to one embodiment, the DATA+ACK packet 1242 may be similar to a CF−ACK+DATA packet used in the point coordination function (PCF) of an 802.11 media access controller (MAC), although the invention is not limited in this regard.

It should be noted that the methods described herein do not have to be executed in the order described, or in any particular order. Moreover, various activities described with respect to the methods identified herein can be executed in serial or parallel fashion. For the purposes of this document, the terms “information” and “data” may be used interchangeably. Information, including parameters, commands, operands, and other data, can be sent and received in the form of one or more carrier waves.

Upon reading and comprehending the content of this disclosure, one of ordinary skill in the art will understand the manner in which a software program can be launched from a computer-readable medium in a computer-based system to execute the functions defined in the software program. One of ordinary skill in the art will further understand the various programming languages that may be employed to create one or more software programs designed to implement and perform the methods disclosed herein. The programs may be structured in an object-orientated format using an object-oriented language such as Java, Smalltalk, or C++. Alternatively, the programs can be structured in a procedure-orientated format using a procedural language, such as assembly or C. The software components may communicate using any of a number of mechanisms well-known to those skilled in the art, such as application program interfaces or inter-process communication techniques, including remote procedure calls. The teachings of various embodiments are not limited to any particular programming language or environment, including Hypertext Markup Language (HTML) and Extensible Markup Language (XML). Thus, other embodiments may be realized.

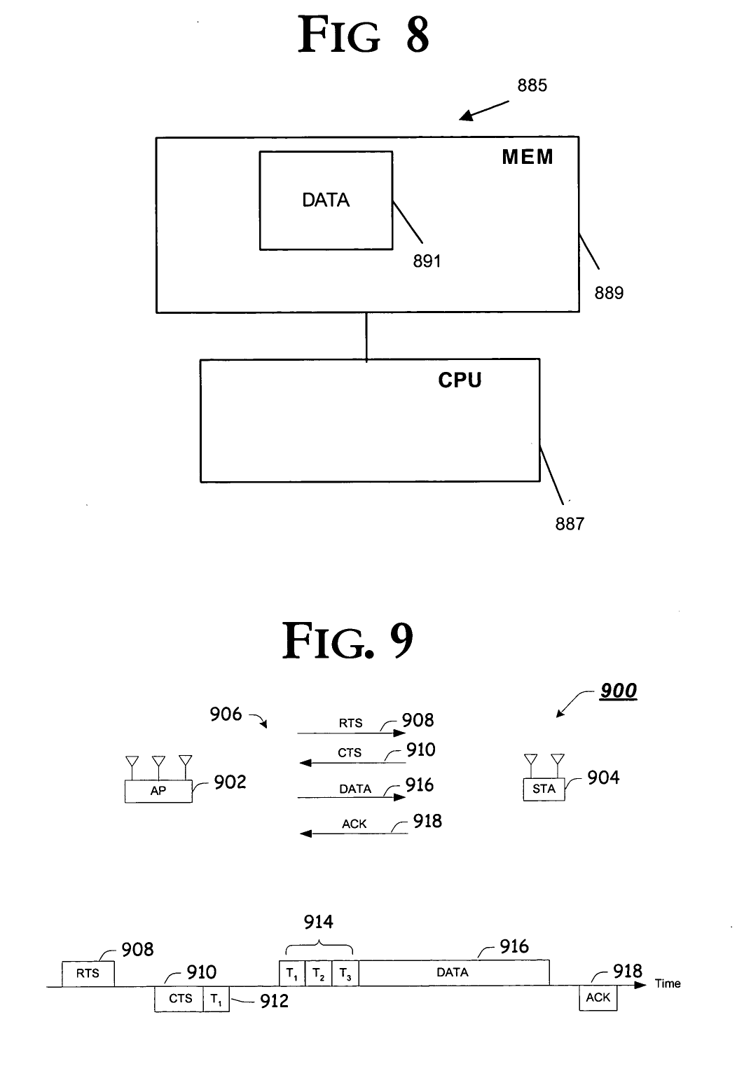

For example, FIG. 8 is a block diagram of an article 885 according to various embodiments, such as a computer, a memory system, a magnetic or optical disk, some other storage device, and/or any type of electronic device or system. The article 885 may comprise a processor 887 coupled to a machine-accessible medium such as a memory 889 (e.g., a memory including an electrical, optical, or electromagnetic conductor) having associated information 891 (e.g., data or computer program instructions), which when accessed, results in a machine (e.g., the processor 887) performing such actions as transmitting a second number of training symbols corresponding to a second number of communication chains in response to receiving a first number of training symbols corresponding to a first number of communication chains. Other activities may include receiving a clear to transmit response and the first number of training symbols at the second number of communication chains, and estimating one or more communications channels associated with the second number of communication chains based on the first number of training symbols. Further activities may include transmitting the second number of training symbols and data, and calibrating some number of transmit and receive chains included in the second number of communication chains based on the second number of training symbols.

In some embodiments, an article including a machine-accessible medium having associated information, wherein the information, when accessed, results in a machine performing such activities as transmitting a first number of training symbols corresponding to a first number of communication chains to solicit a response including a second number of training symbols corresponding to a second number of communication chains. Additional activities may include transmitting a request to transmit and the first number of training symbols, and calibrating the first number of communication chains. Further activities may include receiving a clear to transmit response and the second number of training symbols, and estimating one or more channels associated with the first number of communication chains.

Implementing the apparatus, systems, and methods described herein may result in reducing the overhead used for calibration and training of various devices, including those forming a portion of a MIMO system. For packet sizes of approximately 500-1500 bytes, improvements in efficiency may be on the order of 30%-50%. Thus, this type of operation may in turn provide improved bandwidth utilization, and reduced communication costs.

The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term invention merely for convenience and without intending to voluntarily limit the scope of this application to any single invention or inventive concept if more than one is in fact disclosed.

Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A method comprising:
generating a packet for transmission via a select one or more antenna(e) of a transmitting device; and
including with the generated packet one or more training symbol(s), at least one each for at merely a subset of the number of antenna(e) of the transmitting device, wherein the packet is generated for purposes other than the transmission of the training symbols.

2. A method according to claim 1, wherein the packet is one or more of a data packet, a handshaking packet, an acknowledgement packet, and any combination thereof, and wherein the included training symbol(s) are embedded within, or appended to, the generated packet.

3. A method according to claim 2, wherein the packet is one or more of a request to send (RTS) packet and a clear to send (CTS) packet.

4. A method according to claim 3, wherein the generated packet is used as a training symbol for transmission via at least one select transmit antenna.

5. A method according to claim 4, wherein the at least one transmit antenna is selected as the one providing a best performance metric at a receiver when compared against other transmit antenna options.

6. A method according to claim 5, wherein the performance metric is a signal to noise ratio (SNR).

7. A method according to claim 5, wherein the included one or more training symbols are transmit via a select subset of a plurality of transmit antenna(e).

8. A method according to claim 7, wherein the select subset of transmit antenna include at least a subset of remaining antenna(e) that were not used for transmission of the handshaking packet.

9. A method according to claim 3, wherein the included one or more training symbol(s) are transmit via a select subset of a plurality of transmit antenna(e).

10. A method according to claim 9, wherein the select subset of transmit antenna is selected as the one providing a best performance metric at a receiver when compared against other transmit antenna options.

11. A method according to claim 2, further comprising:
transmitting the packet to a remote device as a training symbol via a select first of a plurality of antenna(e); and
transmitting the included training symbols to the remote device via a select second or more of the plurality of antenna(e) to enable the remote device to perform training.

12. A method according to claim 11, further comprising:
receiving at least a packet from the remote device, wherein the packet is used as a training symbol; and
performing calibration of one or more transmit chains based, at least in part, on channel performance information associated with the received training symbol(s).

13. A storage medium comprising content which, when executed, causes an accessing communication device to implement a method including:
generating a packet for transmission via a select one or more antenna(e) of a transmitting device; and
including with the generated packet one or more training symbol(s), at least one each for at merely a subset of the number of antenna(e) of the transmitting device, wherein the packet is generated for purposes other than the transmission of the training symbols.

14. A storage medium according to claim 13, wherein the packet is one or more of a data packet, a handshaking packet, an acknowledgement packet, and any combination thereof.

15. A storage medium according to claim 14, wherein the packet is a handshaking packet comprising one or more of a request to send (RTS) packet and a clear to send (CTS) packet.

16. A storage medium according to claim 14, wherein the generated packet is used as a training symbol for transmission via at least one select transmit antenna.

17. A storage medium according to claim 16, wherein the at least one transmit antenna is selected as the one providing a best performance metric at a receiver when compared against other transmit antenna options.

18. A storage medium according to claim 17, wherein the included one or more training symbols are transmit via a select subset of a plurality of transmit antenna(e).

19. A storage medium according to claim 18, wherein the select subset of transmit antenna include at least a subset of remaining antenna(e) that were not used for transmission of the handshaking packet.

20. A storage medium according to claim 19, wherein the included one or more training symbol(s) are transmit via a select subset of a plurality of transmit antenna(e).

21. A storage medium according to claim 14, wherein the included one or more training symbol(s) are transmit via a select subset of a plurality of transmit antenna(e).

22. A storage medium according to claim 21, wherein the select subset of transmit antenna is selected as the one providing a best performance metric at a receiver when compared against other transmit antenna options.

23. A storage medium according to claim 14, further comprising instructions to cause the accessing device to:
transmit the generated packet to a remote device as a training symbol via a select first of a plurality of antenna(e); and
transmit the included training symbols to the remote device via a select second or more of the plurality of antenna(e) to enable the remote device to perform training.

24. A storage medium according to claim 23, further comprising content to enable an accessing device to:
receive at least a packet from the remote device, wherein the packet is used as a training symbol; and
perform one or more of training and calibration of one or more transmit chains based, at least in part, on channel performance information associated with the received training symbol(s).

25. An apparatus comprising:
one or more transmit antenna(e), to enable wireless communication with a remote device; and
a controller, coupled with the one or more transmit antenna(e), to generate a packet for transmission via a select one or more of the transmit antenna(e), and to selectively include with the generated packet one or more training symbol(s), at least one each for at merely a subset of the number of antenna(e) of the transmitting device, wherein the packet is generated for purposes other than the transmission of the training symbols.

26. An apparatus according to claim 25, wherein the packet is one or more of a data packet, a handshaking packet, an acknowledgement packet, and any combination thereof, and wherein the training symbol(s) are embedded within, or appended to, the generated packet.

27. An apparatus according to claim 26, wherein the controller generates one or more of a request to send (RTS) packet and a clear to send (CTS) packet as the generated packet.

28. An apparatus according to claim 26, wherein the controller issues the generated packet as a training symbol for transmission via at least one select transmit antenna.

29. An apparatus according to claim 26, wherein the controller selects the at least one transmit antenna for transmission based, at least in part, on an indication of a receive performance metric at the remote device.

30. An apparatus according to claim 29, wherein the select antenna is determined to provide a best receive performance at the remote device as compared to other transmit antenna(e) options.

31. An apparatus according to claim 29, wherein the performance metric is a signal to noise ratio (SNR) at the remote device.

32. An apparatus according to claim 29, wherein the controller selects at least one or more of a remaining subset of the plurality of transmit antenna(e) to transmit the one or more training symbol(s).

33. Am apparatus according to claim 32, wherein the select subset of transmit antenna include at least a subset of remaining antenna(e) that were not used for transmission of the generated packet.

34. An apparatus according to claim 26, further comprising:
a transmitter, coupled between the controller and the transmit antenna(e), to transmit the packet to a remote device as a training symbol via a select first of a plurality of antenna(e), and to transmit the included training symbols to the remote device via a select second or more of the plurality of antenna(e) to enable the remote device to perform training.

35. An apparatus according to claim 26, further comprising:
a receiver, coupled between the controller and one or more receive antenna(e), to receive at least a packet from the remote device, wherein the packet is used as a training symbol, to enable the controller to perform calibration of one or more transmit chains based, at least in part, on channel performance information associated with the received training symbol(s).

36. An apparatus according to claim 35, wherein the transmit antenna(e) and the receive antenna(e) are one in the same.

37. An apparatus comprising:
a storage medium in which to store at least executable content; and
control logic, coupled to the storage medium, to selectively execute at least a subset of the executable content stored therein to generate a packet for transmission via a select one or more of a plurality of transmit antenna(e), and to selectively include with the generated packet one or more training symbol(s), at least one each for at merely a subset of the number of antenna(e) of the transmitting device, wherein the packet is generated for purposes other than the transmission of the training symbols.

38. An apparatus according to claim 37, wherein the packet is one or more of a data packet, a handshaking packet, an acknowledgement packet, and any combination thereof, and wherein the training symbol(s) are embedded within, or appended to, the generated packet.

39. An apparatus according to claim 37, further comprising:
a transmitter, coupled to the control logic, to transmit the packet to a remote device as a training symbol via a select first of a plurality of antenna(e), and to transmit the included training symbols to the remote device via a select second or more of the plurality of antenna(e) to enable the remote device to perform training

40. An apparatus according to claim 39, wherein the control logic selectively executes content to select the first antenna from the plurality of antenna(e) based, at least in part, on a received or perceived indication of channel performance at the remote device.

41. An apparatus according to claim 37, further comprising:
a receiver, coupled with the control logic, to receive at least a packet from the remote device, wherein the packet is used as a training symbol, and to enable the control logic to perform calibration of one or more transmit chains based, at least in part, on channel performance information associated with the received training symbol(s).
